(19) United States
(12) Patent Application Publication
(10) Pub. No.: US 2011/0291859 A1
(43) Pub. Date: Dec. 1, 2011

(54) DRIVER ASSIST SYSTEM WITH A DEVICE FOR DETECTING TRAFFIC SIGNS

(75) Inventors: Andreas KREIS, Schornsheim (DE); Andreas STRAYLE, Floersheim (DE)

(73) Assignee: GM GLOBAL TECHNOLOGY OPERATIONS LLC, Detroit, MI (US)

(21) Appl. No.: 13/116,118

(22) Filed: May 26, 2011

(30) Foreign Application Priority Data
May 26, 2010 (DE) 102010021558.9

(51) Int. Cl. G08G 1/09

(52) U.S. Cl. 340/905

(57) ABSTRACT

A driver assist system includes, but is not limited to a device for detecting traffic signs and/or for receiving and for processing information of a traffic sign on a road shoulder and/or geographical data, particularly with respect to downhill routes, and/or further road users installed in a motor vehicle. The device generates and emits at least one signal perceptible to the driver which informs the driver that a further actuation of an accelerator pedal is not required.

### CROSS-REFERENCE TO RELATED APPLICATION

This application claims priority to German Patent Application No. 102010021558.9, filed May 26, 2010, which is incorporated herein by reference in its entirety.

### TECHNICAL FIELD

The technical field relates to a driver assist system with a device for detecting traffic signs installed in a motor vehicle.

### BACKGROUND

From DE 10 2005 045 049 A1 a navigation device for motor vehicles for supporting an energy-optimized driving style is known, which from the current position data and/or speed data and/or directional data calculates if the motor vehicle based on the geographical circumstances and/or of the traffic situation has to be braked or accelerated or can continue to run or roll without accelerator intervention in order to avoid unnecessary accelerations. The navigation device comprises a device for receiving information regarding the switching status of traffic light systems.

In addition, DE 100 28 130 A1 discloses a system for vehicle guidance in front of crossings and a control unit for vehicle guidance which requests the vehicle driver to drive the vehicle in accordance with a calculated optimal approach process which can be optimized with respect to as low as possible a fuel consumption. The system takes into account situation parameters such as the phase status of a traffic light system at a crossing. The traffic light system sends information regarding its current phase status in a wireless manner.

The prior art proves to be problematic in this regard as elaborate signaling and control takes place, which as a rule intervenes in the driving behavior of the motor vehicle.

### SUMMARY

Based on the prior art described before a driver assist system is to be configured in such a manner that with a simple structure it provides a driver with information allowing him to reduce the fuel consumption of the motor vehicle. A driver assist system comprises a device for the detection of traffic signs and/or for the reception and for the processing of information of a traffic sign at a road shoulder and/or geographical data, particularly with regards to downhill routes and/or other road users installed in a motor vehicle, wherein the device generates and emits at least one signal perceptible to the driver which informs the driver in that a further actuation of an accelerator pedal is not required.

Fuel here is to always mean any form of energy required for the motor drive of motor vehicles. These can be any fuels as well as electric energy. In the following, accelerator pedal is to mean any device to be permanently actuated by the driver in order to influence the speed, i.e. an accelerator, with which engine power is controlled. A traffic sign can more preferably be a traffic sign or a traffic light.

The device for detecting traffic signs utilized in connection with the driver assist system can operate entirely on motor vehicle based and besides the traffic sign proper, does not require any further information. However, it is also conceivable that the device receives and processes information of a traffic sign which can take place over a relatively large distance between the vehicle and the traffic sign. If for example the device recognizes a traffic sign formed as a St. Andrew's Cross, particularly a relatively long time before a driver is able to perceive the traffic sign, the emission initiated through the device of for example an acoustic signal takes place and the driver has an indication that further actuation of an accelerator pedal is not required or practical, since a St. Andrew's Cross points to a railway crossing which has to be approached with caution and reduced speed. Accordingly, the driver can take the foot off the accelerator pedal and utilize the thrust of the motor vehicle in order to approach the traffic sign in a fuel saving manner.

It is additionally possible that the device receives information regarding geographical data, particularly of downhill routes that also have to be identified through corresponding traffic signs, for example via a navigation system or other satellite communication, and informs the driver through corresponding signaling that a further actuation of an accelerator is not required or practical. Following this, the device can process information of other road users, for example measured distances to vehicles traveling ahead or radio information of road users and inform the driver that further actuation of an accelerator pedal is not required or practical. Practically, the device establishes the distance between the motor vehicle and the traffic sign and/or the road user. Because of this it can be unambiguously determined when the driver can be notified so that he approaches the traffic sign or road user in an energetically favorable manner.

A configuration of the device comprises a camera with an image processing system and/or a receiver which communicates with a sender of the traffic sign or the road user. The camera combined with the image processing system can detect a multiplicity of traffic signs or traffic situations and in the event of a detected speed limitation the driver assist system can point out to the driver through a corresponding signal before reaching the traffic sign that he should take the foot off the accelerator pedal for a fuel-saving driving style. If the traffic sign is equipped with a sender that is in communication with a motor vehicle-based receiver, many pieces of information can be transmitted preferentially unidirectionally from the traffic sign to the motor vehicle. The pieces of information can for example comprise the distance to an obstacle or the time to a green phase of a traffic light or the time still remaining of the green phase of a traffic light. By means of this information, the driver assist system can evaluate if or when corresponding signaling informing the driver takes place.

In order to be able to take into account data relevant to the surroundings during the signaling, the device is preferentially coupled to a navigation system. Practically, the signal is visually and/or acoustically and/or haptically perceptible. According to a further development the signal is designed as a symbol displayable in an instrument or display, particularly head-up display. The instrument is usually equipped with a speedometer and/or a tachometer and comprises various information and warning lamps which can be supplemented with a further lamp for the signal in a simple manner. The signal can also be displayed on a graphic display, particularly in a central region of an instrument panel. A head-up display offers a very comfortable version for representing a corresponding signal.

A very quick perception of the signal is achieved in that the signal is carried out as a vibration of the steering wheel and/or accelerator pedal and/or a resistance increase and/or a resetting movement, particularly by a defined travel, of the accelerator pedal. Through the method for operating the driver assist system the driver is prompted not to further actuate the accelerator pedal of the motor vehicle on recognizing a corresponding traffic sign and thus enabled to operate the motor vehicle equipped with the corresponding driver assist system in an energy-saving manner.

### BRIEF DESCRIPTION OF THE DRAWINGS

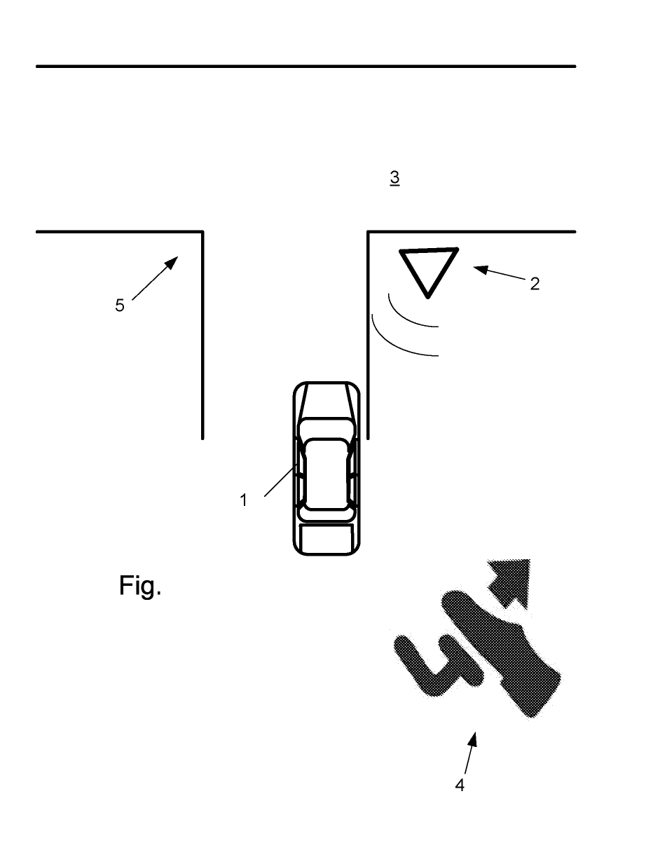

The present invention will hereinafter be described in conjunction with the following drawing FIG. 1, which shows a schematic representation of a traffic situation with a motor vehicle having a driver assist system.

### DETAILED DESCRIPTION

The following detailed description is merely exemplary in nature and is not intended to limit application and uses. Furthermore, there is no intention to be bound by any theory presented in the preceding background or summary or the following detailed description.

A motor vehicle 1 comprises the driver assist system with a device for detecting traffic signs 2 which are equipped with a sender and communicate with a vehicle-based receiver. The sender can transmit information with regard to the traffic sign 2 in this case designed as “yield” to the motor vehicle 1, which more preferably allows a conclusion as to the distance of the traffic sign 2 to the crossing road 3, wherein the driver assist system is able to determine the distance of the motor vehicle to the traffic sign 2. Since the driver of the motor vehicle 1 must not drive up to the traffic sign 2 with excessive speed the device generates at least one signal perceptible to the driver which in the present case is a visually perceptible symbol 4 informing the driver that a further actuation of an accelerator pedal is not required and displays this symbol 4 separately shown in the Figure on a display device within the motor vehicle 1 easily perceptible to the driver. Following this, the driver has the possibility of taking his foot off the accelerator pedal and to approach the junction 5 at which the traffic sign 2 is located in an energy-saving manner subject to utilizing the cruising mode of the motor vehicle.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A driver assist system, comprising:
a first device configured to detect a traffic sign;
a second device configured to receive and process information; and
a third device configured to generate a perceptible signal that indicates further actuation of an accelerator pedal is not required.

2. The driver assist system according claim 1, wherein the second device is configured to receive and process information of the traffic sign on a road shoulder.

3. The driver assist system according to claim 1, wherein the second device is configured to receive and process information of geographical data.

4. The driver assist system according to claim 3, wherein the geographical data is downhill routes.

5. The driver assist system according to claim 1, wherein the second device is configured to receive and process information of a road user installed in a motor vehicle.

6. The driver assist system according to claim 2, further comprising a distance device configured to determine a distance between a motor vehicle and the traffic sign

7. The driver assist system according to claim 5, further comprising a distance device configured to determine a distance between the motor vehicle and the road user.

8. The driver assist system according to claim 2, further comprising a camera with an image processing system configured to communicate with a sender of the traffic sign.

9. The driver assist system according to claim 5, further comprising a camera with an image processing system configured to communicate with a sender of the road user.

10. The driver assist system according to claim 1, further comprising a navigation system.

11. The driver assist system according to claim 1, wherein the perceptible signal is visually perceptible.

12. The driver assist system according to claim 1, wherein the perceptible signal is acoustically perceptible.

13. The driver assist system according to claim 1, wherein the perceptible signal is haptically perceptible.

14. The driver assist system according to claim 1, wherein the perceptible signal is a symbol displayable in an instrument.

15. The driver assist system according to claim 1, wherein the perceptible signal is a symbol displayable in a display.

16. The driver assist system according to claim 1, wherein the perceptible signal is a symbol displayable in a head-up display.

17. The driver assist system according to claim 1, wherein the perceptible signal is embodied as a vibration of a steering wheel.

18. The driver assist system according to claim 1, wherein the perceptible signal is embodied as a vibration of the accelerator pedal.

19. The driver assist system according to claim 1, wherein the perceptible signal is embodied as a resistance increase of the accelerator pedal.

20. The driver assist system according to claim 1, wherein the perceptible signal is embodied as a resetting movement of the accelerator pedal.

21. A method for operating a driver assist system of a motor vehicle, comprising:
detecting a traffic sign on a road shoulder; and
generating a perceptible signal through which a driver is prompted not to further actuate an accelerator pedal of the motor vehicle.

22. The method according to claim 21, wherein detecting the traffic sign comprises optically detecting the traffic sign.

23. The method according to claim 21, wherein detecting the traffic sign comprises receiving information from the traffic sign

24. The method according to claim 21, wherein a symbol is displayed in a head-up display.

25. The method according to claim 21, further comprising increasing an actuation resistance for the accelerator pedal.
